(19) United States
(12) Patent Application Publication
(10) Pub. No.: US 2008/0280202 A1
(43) Pub. Date: Nov. 13, 2008

(54) Conductive composite material

(75) Inventors: Min-Yu Yen, Taitung (TW); Yi-Yie Yan, Hsinchu (TW); Fa-Lin Chen, Taipei (TW)

Correspondence Address: BACON & THOMAS, PLLC, 625 SLATERS LANE, FOURTH FLOOR, ALEXANDRIA, VA, 22314-1176, US

(73) Assignee: Industrial Technology Research Institute, Hsinchu (TW)

(21) Appl. No.: 12/076,800

(22) Filed: Mar. 24, 2008

(30) Foreign Application Priority Data
May 8, 2007 (TW) 96116232

(51) Int. Cl. H01M 4/02; H01B 1/04; H01M 8/02

(52) U.S. Cl. 429/210; 252/502; 429/12

(57) ABSTRACT

The present invention relates to a conductive composite material, comprising 5 to 40% by weight of a copolymer and 60 to 95% by weight of a conductive filler, wherein said copolymer is selected from a copolymer of vinyl terminated rubber-styrene, a copolymer of vinyl terminated rubber-styrene-divinyl benzene, or a copolymer of styrene-divinyl benzene. This conductive material has high conductivity, high mechanical strength and flexibility, and can be mixed with graphite molecules to form a conductive bipolar plate. This invention also relates to an electrode, which is produced from the above-mentioned conductive material.

### BACKGROUND OF THE INVENTION

1. Field of the Invention

The present invention relates to a polymer composite material, particularly relates to a conductive composite material produced from a copolymer and a conductive filler, wherein said copolymer is select from a copolymer of vinyl terminated rubber-styrene-divinyl benzene, a copolymer of vinyl terminated rubber-styrene, or a copolymer of styrene-divinyl benzene, and said conductive composite material can be used to produce an electrode which can be used in electrochemical reactions and broadly applied in fuel cells to be a system power supply.

2. Description of the Related Art

As shown in FIG. 1, the proton exchange membrane fuel cell (PEMFC) 10 comprises a proton exchange membrane 1 that is held between catalyst layers 2, diffusion layers 3, bipolar plates 4, current collectors 5, and end plates 6; and the combination of the proton exchange membrane 1, the catalyst layers 2 and the diffusion layers 3 are defined as a membrane electrode assembly. One side of the membrane electrode assembly is an anode (hydrogen or reformatted gas), where the oxidation reaction occurs; and the other side is a cathode (oxygen or air), where the reduction reaction occurs. When the hydrogen from the anode contacts the catalyst layer 2 (made by platinum or platinum alloy) adjacent to the proton exchange membrane 1, the hydrogen molecules are dissociated to hydrogen ions and electrons. The electrons swim from anode to cathode through an anode-cathode connecting bridge and equipments series-connecting to said bridge, while the hydrogen ions directly pass the membrane electrode assembly from the anode to the cathode. Particularly, said membrane electrode assembly comprises a wet membrane that merely allows hydrogen ions accompanied with H₂O molecules pass through, and other gas molecules cannot pass through it. Also, after the electrons pass through the bridge and come to the cathode, they combine with oxygen to produce oxygen ions, and these oxygen ions further combine with the hydrogen ions from proton exchange membrane 1 to form H₂O molecules. This is so called electrochemical oxidation and reduction reactions.

Electrochemical reactions will give PEMFC electricity generating system several properties such like high efficiency, zero pollution, and rapid reaction. In addition, both the bridge voltage and the reaction zone of the electrodes are enhanced through series connections, and thereby increasing the current. Particularly, when the hydrogen and the oxygen (air) are ceaselessly provided, the need of continuously power supply is satisfied. Since then, PEMFC can not only be used as a small sized system power supply device, but also can be designed as a great electricity generating factory, a dispersion type power supply, or a movable power supply.

The bipolar plates account for most volume and weight of a fuel cell, therefore, the research and development of materials for the bipolar plates are important indicators for the development of fuel cells. The bipolar plates are used for distributing reaction gases to specific reaction zones, separating reaction gases, i.e. hydrogen and oxygen, at the two sides of any one of the plates, conducting electricity and heat, and fixing the membrane electrode assembly. Because the bipolar plates are located in the reaction zone of the fuel cell, they must have properties of corrosion resistance and heat resistance. In addition, there are two other unsolved problems of bipolar plates, namely, increasing the volume utility and reducing the density of these plates. On the whole, the requirements for bipolar plates are high conductivity, air-tightness, chemical corrosion resistance, heat resistance, light weight and microminiaturization, high mechanical strength and low surface roughness; preferably, the bipolar plates should have good working property. Beside the above-mentioned requirements, it is important to lower the cost of the bipolar plates, including the costs of raw-materials and production; moreover, the technology for large-scale production is also required. The bipolar plates having price-benefit and excellent properties will make the fuel cell much more competitive in the market.

The conventional bipolar plates comprise highly compact carbon plates, composite carbon plates and metal plates, and most bipolar plates used in PEMFC are made from highly compact graphite materials. In the conventional production, the raw materials are quite expensive, and the mechanical working of flow grooves also cost a lot. In order to reduce the cost of bipolar plates, therefore, using traditional composite material related technologies in combination with fuel cells is now the main trend. The bipolar plates suitable for fuel cells can be produced by changing the formulation and producing method of the composite materials and using compression molding or injection molding. In the conventional composite material technologies, most raw materials are cheap commercial chemicals, so they have price benefit. In addition, most highly compact carbon plates are produced as flat-plates, and so further mechanical working is needed; however, high molecular composite materials can be directly formed into plates having grooves and poles to reduce the working fee. These highly compact carbon plates are porous materials, and the pores within these plates have to be stuffed by post-treatments, so the cost of post-treatment and the way how to conduct large-scale production are important problems. On the contrary, the materials produced by composite material technologies have better air tightness than conventional carbon plates, and they have no pore to be stuffed. On the whole, the combination of the high molecular composite carbon plates and large-scale production technology is most preferable for bipolar plates.

Taiwan Publication No. 399,348 has disclosed a method for producing a bipolar plate for fuel cells. Said method comprises mixing a conductive material, a resin and a hydrophilic agent, and molding a bipolar plate at the temperature ranged from 250° C. to 500° C. under the pressure ranged from 500 psi to 4000 psi, wherein said resin comprises thermoplastic resins and thermosetting resins, and said conductive material can be graphite powder, carbon black, carbon fiber, and the like.

U.S. Pat. No. 6,436,315 has disclosed a highly conductive molding compound for fuel cell plates, wherein an improved injection molding technology is used to inject a mixture of resin and graphite powder to mold bipolar plates. Also, a variety of additives are categorized and defined in this Patent.

U.S. Pat. No. 6,248,467 has disclosed a bipolar separator plate for fuel cells consisting of a molded mixture of a vinyl ester resin and graphite powder, wherein said graphite powder having a size of 80 to 325 mesh.

Also, US 2005/0001352A1 has disclosed a bipolar separator plate for fuel cells consisting of a molded mixture of a vinyl ester resin and graphite powder, wherein said graphite powder having a size of 10 to 80 mesh.

However, both the conductivity and generating power of these conventional conductive composite materials are not good enough, so the applications of these materials are limited, and it is difficult for them to be used in a great electricity generating factory, a dispersion type power supply, or a movable power supply. Therefore, the way how to break this bottleneck will be the most important issue in the art of high molecular composite carbon-based plates.

### SUMMARY OF THE INVENTION

To solve the problems of low flexibility and low conductivity of traditional conductive composite materials, one object of the present invention is to provide a conductive composite material having advantages of high flexibility, high conductivity, high corrosion resistance, good air tightness, microminiaturization, high mechanical strength, low surface roughness and the like, which is directly blended with graphite in resin, hardened in a mold, and then produced as a bipolar plate having high conductivity.

Another object of the present invention is to provide an electrode, preferably an electrode for proton exchange membrane fuel cells, which is produced from the above-mentioned conductive composite material, and is given the properties of said material.

To achieve the above-mentioned objects, the present invention provides a conductive composite material, comprising 5 to 40% by weight of a copolymer, and 60 to 95% by weight of a conductive filler, wherein said copolymer is selected from a copolymer of vinyl terminated rubber-styrene, a copolymer of vinyl terminated rubber-styrene-divinyl benzene, or a copolymer of styrene-divinyl benzene.

In the preferable embodiment of the present invention, said conductive filler comprises graphite powder, carbon fiber, expanded graphite, carbon black, coke, carbon nanotube, or combinations thereof; more preferably, said conductive filler is a mixture of 65 to 90% by weight of graphite powder, 30 to 5% by weight of carbon fiber and 5 to 10% by weight of expanded graphite.

In the preferable embodiment of the present invention, said copolymer of vinyl terminated rubber-styrene-divinyl benzene is copolymerized in the presence of a free radical initiator from the following components: 1 to 20% by weight of vinyl terminated rubber, 60 to 98% by weight of styrene, and 1 to 20 by weight of divinyl benzene; more preferably, said vinyl terminated rubber is polymerized from acrylnitrile and butadiene.

In the preferable embodiment of the present invention, said copolymer of vinyl terminated rubber-styrene is copolymerized in the presence of a free radical initiator from the following components: 1 to 90% by weight of vinyl terminated rubber, and 10 to 99% by weight of styrene.

In the preferable embodiment of the present invention, said copolymer of styrene-divinyl benzene is copolymerized in the presence of a free radical initiator from the following components: 90 to 99% by weight of styrene, and 1 to 10 by weight of divinyl benzene.

In the preferable embodiment of the present invention, said free radical initiator comprises t-butyl perbenzoate or perbenzoic acid.

In the preferable embodiment of the present invention, said vinyl terminated rubber comprises polybutadiene, natural rubber, polyisopropylene, styrene-butadiene rubber, butyl rubber, nitrile rubber, ethylene-propylene rubber, polychlorobutadiene, polyvinyl chloride, polysiloxane, fluorinated rubber, or combinations thereof.

In the preferable embodiment of the present invention, said vinyl terminated rubber has a weight average molecular weight of between 1,000 and 10,000; more preferably, said vinyl terminated rubber has a weight average molecular weight of between 4,500 and 5,500.

In the preferable embodiment of the present invention, said material further comprises a rheology modifier or a releasing agent; wherein said rheology modifier is magnesium oxide, and said releasing agent comprises fluorine wax, metal soap, hydrocarbon wax, polyethylene, amide wax, fatty acid, fatty alcohol, or fatty ester.

The present invention also provides an electrode, which is produced from the above-mentioned conductive composite material. In the preferable embodiment of the present invention, said electrode is used as a bipolar plate for proton exchange membrane fuel cells.

In comparison with the conventional materials, the conductive composite material of the present invention has higher conductivity. In addition, when the material is used to produce proton exchange membrane fuel cells, said cells are suitable to be used in a great or a movable power system.

### BRIEF DESCRIPTION OF THE DRAWINGS

FIG. 1 is the cross section of a proton exchange membrane fuel cell, in which 1 denotes a proton exchange membrane, 2 denotes catalyst layers, 3 denotes diffuse layers, 4 denotes a bipolar plates, 5 denotes a collector plates, 6 denotes a end plates, and 10 denotes a proton exchange membrane fuel cell.

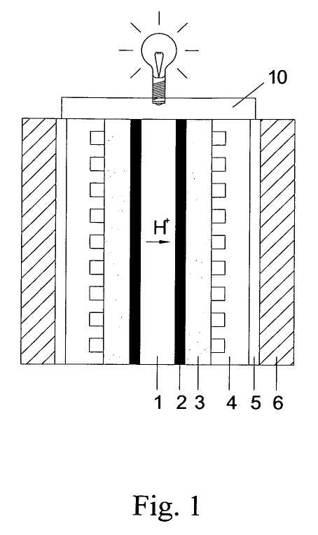

FIG. 2 is an illustrative diagram showing the structure of expanded graphite.

FIG. 3 is an electromicroscopic picture showing the structure of expanded graphite.

FIG. 4 is a curve chart showing the performance analysis of a fuel cell produced from the material of Example 1.

### DETAILED DESCRIPTION OF THE PREFERABLE EMBODIMENTS

In order to enhance the flexibility and conductivity of carbon-based composite plates, mono-layered graphite molecules are used as an auxiliary conductive material in the present invention. The conductive composite material of this invention comprises 5-40% by weight of a copolymer, and 60-95% by weight conductive filler; wherein said copolymer is selected from a copolymer of vinyl terminated rubber-styrene-divinyl benzene, a copolymer of vinyl terminated rubber-styrene, or a copolymer of styrene-divinyl benzene.

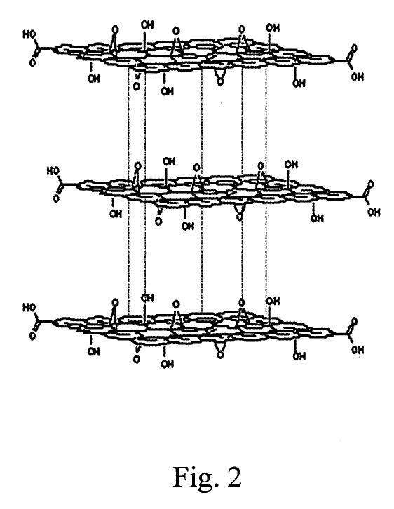

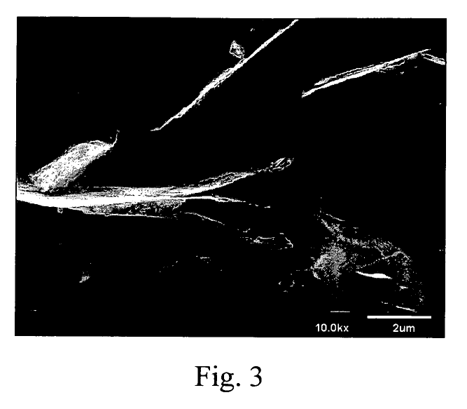

The suitable conductive filler can be graphite powder, carbon fiber, carbon black, coke, carbon nanotube, metal powder, metal wire, or combinations thereof, but these conductive fillers cannot dissolve in the resin. In order to enhance the conductivity of the whole composite material by adding a soluble conductive filler in the resin, the soluble graphite oxide is the most preferable filler. The oxygen-containing group comprised in the graphite oxide would make bulk graphite completely spilt, for example, after heat treatment at 1000 ° C., the graphite oxide expands rapidly and the graphite layers therein are separated into graphite sheets. The structure and the electromicroscopic picture of said graphite sheets are shown in FIGS. 2 and 3. In addition, the copolymer of vinyl terminated rubber, styrene and divinyl benzene is used as a binder of said conductive filler. It makes said composite material has high conductivity, corrosion resistance, air tightness, microminiaturization, high flexibility, low surface roughness, and the like, and the conductive material is applicable in a corrosive environment, such as in electrochemical electrodes.

In the preferable embodiment of the present invention, the conductive composite material comprises 5 to 40% by weight of a copolymer, and 60 to 95% by weight of a conductive filler, wherein said conductive filler is a mixture of graphite powder, carbon fiber and expanded graphite; for example, said conductive filler is a mixture of 65 to 90% by weight of graphite powder, 30 to 5% by weight of carbon fiber and 5 to 10% by weight of expanded graphite.

The three-dimensional network structures of the copolymers used in this invention, i.e. the copolymer of vinyl terminated rubber (VTBN), styrene and divinyl benzene, the copolymer of styrene and divinyl benzene, and the copolymer of vinyl terminated rubber and styrene, are shown in the following formulae (I), (II) and (III), respectively.

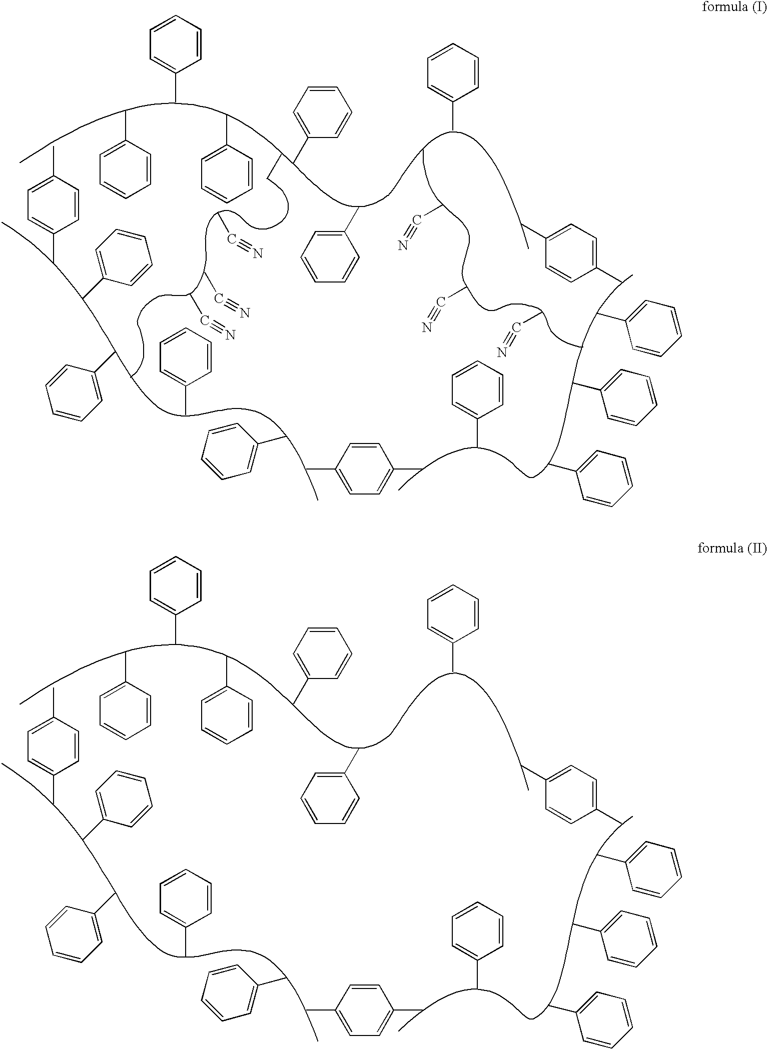

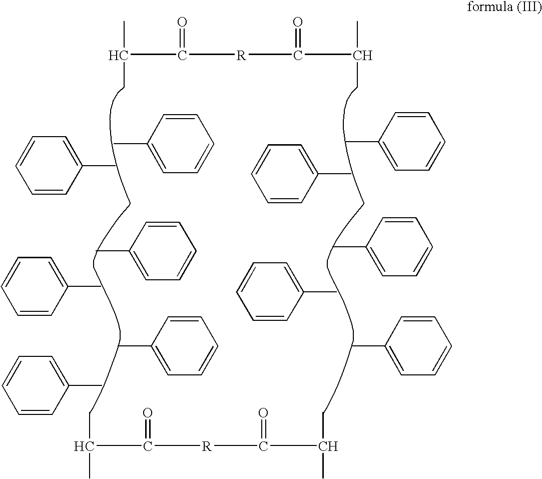

wherein R is a copolymer of acrylnitrile and butadiene, which is a long chain molecule of the skeleton.

In the preferable embodiments of the present invention, the copolymer is the copolymer of vinyl terminated rubber-styrene-divinyl benzene.

Said copolymer of vinyl terminated rubber-styrene-divinyl benzene is copolymerized in the presence of a free radical initiator from 1-20% by weight of vinyl terminated rubber, 60-98% by weight of styrene, and 1-20% by weight of divinyl benzene. Said copolymer of vinyl terminated rubber-styrene is copolymerized in the presence of a free radical initiator from 1-90% by weight of vinyl terminated rubber, and 10-99% by weight of styrene. Said copolymer of styrene-divinyl benzene is copolymerized in the presence of a free radical initiator from 90-99% by weight of styrene, and 1-10% by weight of divinyl benzene.

Preferably, said vinyl terminated rubber is polymerized from acrylnitrile and butadiene.

In one preferable embodiment, said copolymer of vinyl terminated rubber-styrene is the copolymer of acrylnitrile-butadiene-styrene, which is copolymerized in the presence of a free radical initiator from 14-64% by weight of acrylnitrile, 4-24% by weight of butadiene, and 20-80% by weight of styrene.

The suitable free radical initiator of the present invention comprises, but not limit to, t-butyl perbenzoate (TBPB) or perbenzoic acid.

The conductive composite material of the present invention can further comprises, if needed, a rheology modifier or a releasing agent; wherein the rheology modifier comprises, but not limit to, magnesium oxide; and the releasing agent comprises, but not limit to, fluorine wax, metal soap, hydrocarbon wax, polyethylene, amide wax, fatty acid, fatty alcohol, or fatty ester. The amounts of the rheology modifier and the releasing agent are not specially limited, which can be altered according the needs for practical use. Also, a polystyrene low-shrinkage agent can be added, if needed, to reduce the size error caused by shrinkage during molding.

In addition, the present invention also provides an electrode produced by the above-mentioned conductive composite material, for example, a bipolar plate for proton exchange membrane fuel cells. Basically, the conductive composite material of the present invention can be applied in electrochemistry and related art because it not only has properties such as high conductivity, corrosion resistance, air tightness, and the like, but also has higher conductivity, higher flexibility and greater microminiaturization than the traditional materials.

After molding, the molded articles produced by the conductive composite material of the present invention has a flexibility of 6000 psi and more, a tensile strength of 3400 psi and more, a conductivity of 150-200 S/cm, and other properties such as corrosion resistance, air tightness, and the like. Therefore, the conductive composite material of the present invention is suitable to be used as electrode materials, particularly, as a bipolar plate of proton exchange membrane fuel cells. The porous bipolar plate of said fuel cells has advantages such as high chemical reaction efficiency of combustion gases, high generating power, low cost of the production and design of the cells, light weight and small sizes of the cells, and the bipolar plate can be used in the electric systems of vehicles such as cars, ships and airplanes.

The following examples are used to demonstrate the technologies and features of the present invention; however, these examples are not used to limit this invention, and those skilled in the art can make a variety of alterations and modifications without departing the spirit and scope of this invention.

### EXAMPLES

### Example 1

### Plates Produced from a Copolymer of VTBN-Styrene-Divinyl Benzene and a Carbon Material Comprising Expanded Graphite

### The Preparation of Expanded Graphite:

200 g commercial purchased graphite oxide is placed in a stainless steel tank of 3 liters capacity, then immediately sends into a furnace at 1000° C., and heated in the ambient air for 60 seconds to expand the graphite. After the expansion, the expanded graphite is taken out and cooled at room temperature.

### The Preparation of Bipolar Plates:

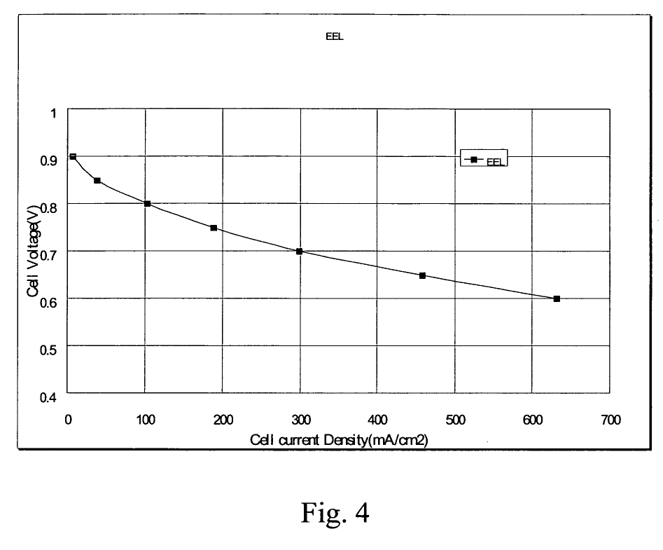

The copolymer of VTBN-styrene-divinyl benzene is kneaded with a powder-formed carbon material comprising of graphite powder, expanded graphite and carbon fiber, to give a homogenous bulk molding compound (BMC), wherein the amount of said carbon material is 75% by weight. The free radical initiator used is t-butyl perbenzoate (TBPB), the solvent used is styrene, and the releasing agent used is fluorine wax. These components are selected not only because they are suitable for bipolar plates, the price factor is also taken into consideration. The proportion of these components is shown in table 1. The bipolar plates obtained in this Example are then assembled to a fuel cell having a single cell structure, and the properties of the cell is tested by the well-known single-cell method under the conditions as below: hydrogen/air=1:1 (flow rate), 16 serpentine channels, the bipolar plate=20 cm×20 cm, the reaction zone=16 cm×16 cm, reaction temperature=65° C. The obtained test results are shown in FIG. 4. The output voltage is 0.6-0.9 V when the current density of the cell is 0-600 mA/cm². FIG. 4 also shows that the fuel cell produced from the bipolar plate of the present invention has excellent power generating efficiency.

TABLE 1

| | | | Comparative |
|---|---|---|---|
| Components | | Example 1 | Example 1 |
| carbon | graphite powder + carbon fiber | 70% | 75% |
| material | expanded graphite | 5% | |

| | | |
|---|---|---|
| VTBN | 5% | 5% |
| divinyl benzene | 1.25% | 1.25% |
| styrene monomer | 18.75% | 18.75% |
| t-butyl perbenzoate (TBPB) | 3 phr | 3 phr |
| fluorine wax | 3 phr | 3 phr |

phr: the abbreviation of Parts per Parts Hundred Resin. For example, when 100 parts by weight of the copolymer of VTBN-divinyl benzene-styrene is mixed with 1 part by weight of fluorine wax, the concentration of the fluorine wax is 1 phr.

The preparation steps of Example 1 are listed as below:
a. placing 200 g of VTBN, 50 g of divinyl benzene, 750 g of styrene, 30 g of free radical initiator (TBPB) and 30 g of releasing agent (fluorine wax) in a beaker, and mixing these components into a solution;
b. placing the mixed solution from step a in a high-speed stirrer, and stirring by emulsifying blades for 10 to 20 minutes;
c. feeding the solution from step b, 2600 g of graphite powder, 200 g of carbon fiber and 200 g of expanded graphite into a mixture molding kneader (BMC Kneader), and kneading by Masticator (high-strength stirring blades) for 60 to 90 minutes;
d. preheating hot-pressing molds to 180° C., and placing a suitable amount of the mixture from step c into a injection chamber;
e. clamping the upper and lower molds until the mold clamping force reaches 100-200 kg/cm², and maintaining the force for 3 minutes to harden the mixture to an article;
f. releasing the article from the molds, and placing said article in an oven at 180° C. for 24 hours to ensure the mixture is completely hardened.

### Comparative Example 1

### Plates Produced from a Copolymer of VTBN-Styrene-Divinyl Benzene and a Carbon Material

In Comparative Example 1, the copolymer of VTBN-styrene-divinyl benzene is kneaded with a carbon material to give a homogeneous bulk molding compound (BMC), wherein the amount of said carbon material (graphite powder+carbon fiber) is about 75% by weight. The free radical initiator used is t-butyl perbenzoate (TBPB), the solvent used is styrene, and the releasing agent used is fluorine wax. The selection of these components is based on the criteria the same as Example 1. The proportion of these components is shown in Table 1.

The preparing steps of Comparative Example 1 are listed as below:
a. placing 200 g of VTBN, 50 g of divinyl benzene, 750 g of styrene, 30 g of free radical initiator (TBPB) and 30 g of releasing agent (fluorine wax) in a beaker, and mixing these components into a solution;
b. placing the mixed solution from step a in a high-speed stirrer, and stirring by emulsifying blades for 10 to 20 minutes;
c. feeding the solution from step b, 2800 g of graphite powder and 200 g of carbon fiber into a mixture molding kneader (BMC Kneader), and kneading by Masticator (high-strength stirring blades) for 60 to 90 minutes;
d. estimating and weighting the mixture from step c, preheating hot-pressing molds to 180° C., and then placing a suitable amount of the mixture from step c into a injection chamber;
e. clamping the upper and lower molds until the mold clamping force reaches 100-200 kg/cm², and maintaining the force for 3 minutes to harden the mixture to an article;
f. releasing the article from the molds, and placing said article in an oven at 180° C. for 24 hours to ensure the mixture is completely hardened.
   The following Table 2 shows the physical properties of the plates produced in Example 1 and Comparative Example 1

TABLE 2

| | Example 1 | |
|---|---|---|
| | 5 wt % expanded | Comparative Example 1 |
| | graphite | 0 wt % expanded graphite |
| specific resistance | 0.00583 Ω-cm | 0.00640 Ω-cm |
| compress strength | 6217 psi | 6215 psi |

From the results of Table 2, we find that the conductivity of the plate produced in Example 1 is obviously higher than that produced in Comparative Example 1 because the expanded graphite is added as a conductive filler, in addition, the compress strength is not influenced by the expanded graphite. Since then, it is clear that the conductive composite material of the present invention which can enhance the conductivity is much more suitable to produce the bipolar plate for fuel cells.

### Example 2

### Plates Produced from a Copolymer of VTBN-Styrene and a Carbon Material

In Example 2, the copolymer of VTBN-styrene is kneaded with a carbon material to give a homogeneous bulk molding compound (BMC), wherein the amount of said carbon material (graphite powder+carbon fiber) is 75% by weight. The free radical initiator used is t-butyl perbenzoate (TBPB), the solvent used is styrene, and the releasing agent used is fluorine wax. These components are selected not only because they are suitable for bipolar plates, the price factor is also taken into consideration. The proportion of these components is shown in Table 3.

TABLE 3

| | | Comparative | Comparative |
|---|---|---|---|
| Components | Example 2 | Example 2 | Example 3 |
| graphite powder + carbon fiber | 75% | 75% | 75% |
| VTBN | 12.5% | | |
| rubber-reinforced vinyl ester | | 15% | |
| resin | | | |
| vinyl ester resin | | | 15% |
| styrene monomer | 12.5% | 10% | 10% |
| t-butyl perbenzoate (TBPB) | 3 phr | 3 phr | 3 phr |
| fluorine wax | 3 phr | 3 phr | 3 phr |

phr: the abbreviation of Parts per Parts Hundred Resin. In Table 3, when 100 parts by weight of resin materials composed of VTBN, rubber-reinforced vinyl ester resin, vinyl ester resin and styrene monomer mixed with 1 of part by weight fluorine wax, the concentration of the fluorine wax is 1 phr.

The preparation steps of Example 2 are listed as below:
a. placing 500 g of VTBN, 500 g of styrene, 30 g of free radical initiator (TBPB) and 30 g of releasing agent (fluorine wax) in a beaker, and mixing these components into a solution;
b. placing the mixed solution from step a in a high-speed stirrer, and stirring by emulsifying blades for 10 to 20 minutes;
c. feeding the solution from step b, 2950 g of graphite powder and 50 g of carbon fiber into a mixture molding kneader (BMC Kneader), and kneading by Masticator (high-strength stirring blades) for 60 to 90 minutes;
d. estimating and weighting the mixture from step c, preheating hot-pressing molds to 180° C., and then placing a suitable amount of the mixture from step c into a injection chamber;
e. clamping the upper and lower molds until the mold clamping force reaches 100-200 kg/cm², and maintaining the force for 3 minutes to harden the mixture to an article;
f. releasing the article from the molds, and placing said article in an oven at 180° C. for 24 hours to ensure the mixture is completely hardened.

### Comparative Example 2

### Plates Produced from Rubber-Reinforced Vinyl Ester Resin and a Carbon Material

In Comparative Example 2, the rubber-reinforced vinyl ester resin is kneaded with a carbon material to give a homogeneous bulk molding compound (BMC), wherein the amount of said rubber-reinforced vinyl ester resin is 15% by weight, and the amount of said carbon material (graphite powder+carbon fiber) is about 75% by weight. The free radical initiator used is t-butyl perbenzoate (TBPB), the solvent used is styrene of about 10% by weight, and the releasing agent used is fluorine wax. The selection of these components is based on the criteria the same as Example 2. The proportion of these components is shown in Table 3.

The preparing steps of Comparative Example 2 are listed as below:
a. placing 600 g of rubber-reinforced vinyl ester resin, 400 g styrene monomer, 30 g of free radical initiator and 30 g fluorine wax in a beaker, and mixing these components into a solution;
b. placing the mixed solution from step a in a high-speed stirrer, and stirring by emulsifying blades for 10 to 20 minutes;
c. feeding the solution from step b, 2800 g of graphite powder and 200 g of carbon fiber into a mixture molding kneader (BMC Kneader), and kneading by Masticator (high-strength stirring blades) for 60 to 90 minutes;
d. estimating and weighting the mixture from step c, preheating hot-pressing molds to 180° C., and then placing a suitable amount of the mixture from step c into a injection chamber;
e. clamping the upper and lower molds until the mold clamping force reaches 100-200 kg/cm², and maintaining the force for 3 minutes to harden the mixture to an article;
f. releasing the article from the molds, and placing said article in an oven at 180° C. for 24 hours to ensure the mixture is completely hardened.

### Comparative Example 3

### Plates Produced from Vinyl Ester Resin and a Carbon Material

In Comparative Example 3, the vinyl ester resin is kneaded with a carbon material to give a homogeneous bulk molding compound (BMC), wherein the amount of said vinyl ester resin is about 15% by weight, and the amount of said carbon material (graphite powder+carbon fiber) is about 75% by weight, the solvent used is styrene of about 10% by weight, the free radical initiator used is TBPB of 30 g, and the releasing agent used is fluorine wax. The selection of these components is based on the criteria the same as Example 2. The proportion of these components is shown in Table 3.

The preparing steps of Comparative Example 3 are listed as below:
a. placing the solvent into a container, then adding 600 g of vinyl ester resin, 400 g of styrene monomer and 30 g of releasing agent, and mixing these components into a solution;
b. placing the mixed solution from step a in a high-speed stirrer, and stirring by emulsifying blades for 10 to 20 minutes;
c. feeding the solution from step b, 2950 g of graphite powder and 50 g of carbon fiber into a mixture molding kneader (BMC Kneader), and kneading by Masticator (high-strength stirring blades) for 60 to 90 minutes;
d. estimating and weighting the mixture from step c, preheating hot-pressing molds to 180° C., and then placing a suitable amount of the mixture from step c into a injection chamber;
e. clamping the upper and lower molds until the mold clamping force reaches 100-200 kg/cm², and maintaining the force for 3 minutes to harden the mixture to an article;
f. releasing the article from the molds, and placing said article in an oven at 180° C. for 24 hours to ensure the mixture is completely hardened.
   The properties of the composite materials produced in the above-mentioned Example 2, Comparative Examples 2 and 3 are listed in Table 4 as below. Example 2 discloses an article produced from the composite material of the present invention comprising the copolymer of VTBN-styrene and graphite powder, wherein the VTBN and the styrene are used as crossing agents, and said copolymer is used as a binder of the particles of said graphite powder. On the other hand, Comparative Example 2 disclosed an article produced from the material mixed by conventional rubber-reinforced vinyl ester resin and graphite, and Comparative Example 3 disclosed an article produced from the material directly mixed by conventional vinyl ester resin and graphite. From the results of Table 4, we find that the article of Example 2 has better flexibility and conductivity than those of Comparative Examples 2 and 3, and it is clear that the conductive composite material of the present invention, which is a flexible and conductive composite material, has more advantages than the conventional conductive materials.

TABLE 4

| | | Comparative | Comparative |
|---|---|---|---|
| Properties | Example 2 | Example 2 | Example 3 |
| flexibility (%) | 32% | 6.2% | 1.5% |
| heat resistant temperature (° C.) | 200 | 200 | 200 |
| conductivity (S/cm) | 155 | 152 | 148 |
| corrosion resistance (μA/cm²) | <1 | <1 | <1 |
| (in 0.5 M sulfuric acid | | | |
| aqueous solution) | | | |
| specific gravity | 1.57 | 1.65 | 1.62 |
| air tightness | good | good | good |

What is claimed is:

1. A conductive composite material, comprising:
5 to 40% by weight of a copolymer, and
60 to 95% by weight of a conductive filler,
wherein said copolymer is selected from a copolymer of vinyl terminated rubber-styrene, a copolymer of vinyl terminated rubber-styrene-divinyl benzene, or a copolymer of styrene-divinyl benzene.

2. The conductive composite material according to claim 1, wherein said conductive filler comprises graphite powder, carbon fiber, expanded graphite, carbon black, coke, carbon nanotube, or combinations thereof.

3. The conductive composite material according to claim 1, wherein said conductive filler is a mixture of 65 to 90% by weight of graphite powder, 30 to 5% by weight of carbon fiber and 5 to 10% by weight of expanded graphite.

4. The conductive composite material according to claim 1, wherein said copolymer of vinyl terminated rubber-styrene is copolymerized in the presence of a free radical initiator from the following components:
1 to 90% by weight of vinyl terminated rubber, and
10 to 99% by weight of styrene.

5. The conductive composite material according to claim 1, wherein said copolymer of vinyl terminated rubber-styrene-divinyl benzene is copolymerized in the presence of a free radical initiator from the following components:
1 to 20% by weight of vinyl terminated rubber,
60 to 98% by weight of styrene, and
1 to 20 by weight of divinyl benzene.

6. The conductive composite material according to claim 1, wherein said copolymer of styrene-divinyl benzene is copolymerized in the presence of a free radical initiator from the following components:
90 to 99% by weight of styrene, and
1 to 10 by weight of divinyl benzene.

7. The conductive composite material according to claim 4, wherein said free radical initiator comprises t-butyl perbenzoate or perbenzoic acid.

8. The conductive composite material according to claim 5, wherein said free radical initiator comprises t-butyl perbenzoate or perbenzoic acid.

9. The conductive composite material according to claim 6, wherein said free radical initiator comprises t-butyl perbenzoate or perbenzoic acid.

10. The conductive composite material according to claim 1, wherein said vinyl terminated rubber comprises polybutadiene, natural rubber, polyisopropylene, styrene-butadiene rubber, butyl rubber, nitrile rubber, ethylene-propylene rubber, polychlorobutadiene, polyvinyl chloride, polysiloxane, fluorinated rubber, or combinations thereof.

11. The conductive composite material according to claim 1, wherein said vinyl terminated rubber is polymerized from acrylnitrile and butadiene.

12. The conductive composite material according to claim 1, wherein said vinyl terminated rubber has a weight average molecular weight of between 1,000 and 10,000.

13. The conductive composite material according to claim 12, wherein said vinyl terminated rubber has a weight average molecular weight of between 4,500 and 5,500.

14. The conductive composite material according to claim 1, which further comprises a rheology modifier or a releasing agent.

15. The conductive composite material according to claim 14, wherein said rheology modifier is magnesium oxide.

16. The conductive composite material according to claim 14, wherein said releasing agent comprises fluorine wax, metal soap, hydrocarbon wax, polyethylene, amide wax, fatty acid, fatty alcohol, or fatty ester.

17. An electrode produced from the conductive composite material according to claim 1.

18. The electrode according to claim 17, which is used as a bipolar plate of proton exchange membrane fuel cells.
